(19) United States
(12) Patent Application Publication
(10) Pub. No.: US 2023/0222568 A1
(43) Pub. Date: Jul. 13, 2023

(54) PRODUCT TRANSACTION MANAGEMENT COMPUTER, PRODUCT TRANSACTION SYSTEM, AND PRODUCT TRANSACTION METHOD

(71) Applicant: Seong Min YOON, Guri-si (KR)

(72) Inventor: Seong Min YOON, Guri-si (KR)

(21) Appl. No.: 18/000,824

(22) PCT Filed: Jun. 1, 2021
(86) PCT No.: PCT/KR2021/006810

§ 371 Date: Dec. 6, 2022

(30) Foreign Application Priority Data
Jun. 8, 2020 (KR) 10-2020-0068821

(51) Int. Cl. G06Q 30/0601; G06Q 20/40

(52) U.S. Cl. CPC G06Q 30/0637; G06Q 20/4014

(57) ABSTRACT

The present invention relates to a product transaction management computer, a product transaction system, and a product transaction method. The present invention provides a product transaction management computer, a product transaction system including the product transaction management computer, and a product transaction method using the product transaction management computer. In the system including the product transaction management computer for operating and managing an online shopping mall, the product transaction management computer is characterized by comprising: a means for acquiring approval for a product transaction using a dedicated account of a product purchaser from at least one non-related person not related to the product purchaser when the product purchaser requests settlement of the product purchase using the dedicated account; and a means for the product purchaser to complete the settlement according to the approval for the product transaction from the non-related person.

### BACKGROUND OF THE INVENTION

### Field of the Invention

The present invention relates to a product transaction management computer, a product transaction system, and a product transaction method. More particularly, the present invention relates to a product transaction management computer, a product transaction system, and a product transaction method which in an e-commerce system such as an online shopping mall for trading products or services, performs quickly and without errors the user authentication of the user using the online shopping mall to strengthen the security of authentication, uses a dedicated account with improved security and transaction speed in relation to the payment of product transactions between the user and the online shopping mall, achieves the strengthen of security of the payer and rapid payment when paying for a product purchase in an online shopping mall, and regarding sellers who sell products in online shopping malls, activates e-commerce by differentiating sales commissions through product marketability and returning costs to sellers or buyers according to product marketability results.

### Description of the Related Art

In general, online product transactions are performed by registering product information in a space such as an online shopping mall and making purchases by users visiting a shopping mall website or a mobile shopping mall. Here, online shopping malls include stand-alone shopping malls that each product seller owns and sells only their own products, and store-type shopping malls in which various sellers are located and a shopping mall operator acts as a sales agent.

A conventional online store type shopping mall is a system in which a seller registers product information to be sold by selecting a product category in the shopping mall, a buyer performs the product transaction by selecting and purchasing a product exposed on the shopping mall, and a shopping mall operator deducts a certain amount from the selling price of the product in the name of sales commission and settles it to the seller. In this process, the buyer performs a user authentication in the shopping mall by any means, the purchase is made by means of credit card, account transfer, or bank transfer as a payment method, and the seller's product information is exposed according to various settings in the shopping mall.

In addition, the shopping mall operator secures a set fee for product transaction and the seller pays the fee regardless of the status of exposure to the shopping mall.

In this case, it is common for the seller to set excessive fees for product transactions, and in particular, the most burdensome fee is unavoidable when paying by credit card.

In addition, a structure in which a separate fee (advertising fee) is paid is operated in order to expose the seller's product to an advantageous location in the shopping mall. There is a problem in that the cost for exposing the product in an advantageous position is excessive, and the product of sellers who cannot bear the cost is excluded from the shopping mall.

As an invention related to product exposure ranking and cost reduction in a shopping mall, in Korean Patent Laid-open No. 10-2014-0031412 (published date: Mar. 13, 2014), there is published a shopping mall server, a system including the same, and a sales method using the same.

The publication invention is an invention relating to a server, system and method which allows a product seller to register a product by additionally selecting a lottery sales method when registering a product to be sold without reconfiguring the shopping mall system, and returns all costs for determining the exposure ranking of product information provided by the seller to the consumer, and uses the size of the consumer benefit as a factor in determining the exposure ranking, and carries out sales in a lottery manner using the lottery winning numbers where the lottery process is opened.

The disclosed invention is an invention in which all costs for determining the exposure ranking of products provided by the seller are returned to the consumer, and the size of the consumer benefit is used as a factor in determining the exposure ranking.

The disclosed invention has a configuration in which the seller refunds the advertisement cost paid for determining the product exposure ranking to the consumer, but has the problem of the prior art in that the advertisement fee must be paid to secure the product exposure ranking.

As an invention related to shopping mall transaction payment and profit distribution, in Korean Patent Laid-open No. 10-2000-0058839 (published date: Oct. 5, 2000), there is published an electronic payment system and method using an electronic wallet containing a bank account number.

The disclosed invention has a configuration in which an electronic payment system includes a storage device; a processor connected to the storage device; and an electronic payment program stored in a storage device to control a processor, wherein the electronic payment program includes a module for receiving a registration application from a customer through a customer terminal connected through the Internet and generating a customer's electronic wallet; a module for receiving a bank account number from a customer and registering it in the customer's electronic wallet; a module that receives a payment approval request from an Internet shopping mall according to product purchase and payment decisions using an electronic wallet; a module requesting a financial system of an affiliated financial company to transfer a payment amount from a bank account number registered in an electronic wallet used for payment to a bank account number of an electronic payment server operator; and a module for receiving payment approval from the financial system and transmitting approval information to the Internet shopping mall.

According to the disclosed invention, an operator of an electronic payment server generates profits equivalent to credit card fees and distributes the profits to transaction parties, so that all transaction parties participating in electronic commerce can obtain transaction profits.

The disclosed invention is a configuration which performs payment using bank account information instead of credit card payment using an electronic wallet, so that the operator generates revenue from fees generated during credit card payment and distributes it as revenue to transaction parties participating in e-commerce. The disclosed invention has no special details except for using a bank account number instead of a credit card payment, and there is a problem in that a security problem that cannot be dealt with when an error occurs in an electronic wallet may arise.

Therefore, an invention related to online product transaction having the following characteristics is desired.

A user authentication of the user's identity is performed through an identity authentication of the user by related persons including acquaintances of the user. The users whose the user authentication has been confirmed open their own dedicated account for financial transactions, including product transactions. In the case of product transaction, payment is made through the user's own dedicated account, but non-related persons who are not related to the user approve the product transaction details and payment details. Incidental costs such as advertisements required to sell products are calculated using a numerical determination system. Incidental expenses calculated under the approval of the non-related persons are deducted from the settlement amount, and the result ledger is shared by the seller, the unrelated persons, and the operator. In addition, sellers perform product validation of products registered in online shopping malls by using a collective intelligence convergence system or by evaluation by the non-related persons. The product transaction system determines the exposure ranking of products according to the results of product validation, and discounts or exempts sales commissions for products of sellers that are not included in the set product validation category so that products can be sold at low prices. As a result, since cost reduction is made to users who are buyers and sellers, online product transaction can be activated.

### SUMMARY OF THE INVENTION

The present invention has been made in an effort to provide a product transaction management computer, a product transaction system, and a product transaction method in which in online product transaction, the buyer of the product is verified an identity authentication by at least one related person related to the buyer, and the buyer whose the identity authentication is confirmed generates a dedicated account to receive approval of the transaction details from non-related person when transacting the product, and the buyer performs product transactions using the dedicated account generated based on the approval of the non-related persons.

In addition, the present invention has been made in an effort to provide a product transaction management computer, a product transaction system, and a product transaction method in which in an online product transaction, when a buyer pays for a product, payment for the product transaction is made through approval of the buyer's financial transaction details and product purchase payment details by at least one non-related person of the buyer.

In addition, the present invention has been made in an effort to provide a product transaction management computer, a product transaction system, and a product transaction method in which in an online product transaction, a product marketability of the product registered by the seller is performed by using a collective intelligence convergence system or evaluated by non-related persons, and the exposure ranking of products registered in the online product transaction system is determined according to the result of product marketability.

In addition, the present invention has been made in an effort to provide a product transaction management computer, a product transaction system, and a product transaction method which in an online product transaction, performs a product marketability of the product registered by the seller by using a collective intelligence convergence system or evaluating by non-related persons, and calculates average incidental costs such as advertising costs for products whose product marketability has been confirmed using a numerical determination system, and performs product transactions after obtaining approval from non-related persons unrelated to the buyer for the transaction details in which the amount corresponding to the incidental cost calculated during the product transaction is deducted from the payment amount.

According to a first aspect of the present invention, a product transaction system includes a product transaction management computer which operates and manages an online shopping mall for product transactions and manages exposure rankings of products registered in the online shopping mall, sales commissions, payment, and the like; a data storage computer including a data storage unit that is connected to or included in the product transaction management computer and stores data including user information, seller information, product selling price information, commission information, etc. performing product transactions in the online shopping mall, and a contents storage unit for storing product information contents of sellers registered or to be registered in the online shopping mall; an identity authentication system which performs user authentication of a user who is connected to the product transaction management computer and performs product transaction through identity verification of at least one related person of the user; a financial transaction system which generates and manages a dedicated account of the user for which user authentication has been completed for the financial transactions and the product transactions in online shopping mall, and performs financial transactions and product transactions through the dedicated account based on the approval of at least one non-related person unrelated to the user; a collective intelligence convergence system which determines the exposure ranking of products registered in the online shopping mall and performs the product marketability of product information in the product transaction management computer to determine a sales commission of the product; a numerical determination system which calculates incidental costs such as advertising costs required to sell similar products of the seller in the online shopping mall; and a product transaction shopping mall which manages and operates by the product transaction management computer that registers product information of sellers and performs online product transactions.

According to a second aspect of the present invention, a product transaction system includes a product transaction management means which operates and manages the online shopping mall; an identity authentication means which performs user authentication by obtaining identity verification of at least one related person related to the user in order to open a dedicated account for product transaction in the online shopping mall; and a financial transaction means which generates and manages a dedicated account for the user whose user authentication has been completed to apply for financial transactions and product transactions in the online shopping mall, and completes the financial transaction or payment of product transaction by obtaining approval from at least one non-related person unrelated to the user when the user performs a financial transaction or payment of product transaction using the dedicated account.

According to a third aspect of the present invention, a product transaction system includes a product transaction management means which operates and manages the online shopping mall, a product marketability verification means which verifies the level of factors such as quality, price, and competitiveness with similar products registered by the seller in the product transaction management means by using a collective intelligence convergence system, and a product exposure management means which determines an exposure ranking or exposure state of products registered in the online shopping mall according to a verification result of product marketability.

According to a fourth aspect of the present invention, a product transaction system includes a product transaction management means which operates and manages the online shopping mall, a product marketability verification means which verifies the level of elements such as quality, price, and competitiveness with similar products registered by the seller in the product transaction management means by using a collective intelligence convergence system, an incidental cost calculation means which calculates incidental costs, such as advertising costs, required when similar products are sold in other media in relation to the product whose product marketability verification has been completed, using a numerical determination system, a product transaction amount settlement means which performs a product transaction after obtaining approval from at least one non-related person unrelated to the user for the transaction details in which the amount corresponding to the incidental cost calculated during the product transaction of the product in the online shopping mall is deducted from the product transaction payment amount, and a transaction details ledger sharing means which shares the product transaction details completed in the product transaction amount settlement means as a ledger among users, sellers and non-related persons.

According to a fifth aspect of the present invention, a product transaction method including: requesting, by a user terminal, identity authentication for user authentication of a user by connecting to an identity authentication system; performing, the identity authentication system, the identity verification of the user based on identity verification information of the user provided by at least one related person related to the user; applying, by the user terminal, opening of a dedicated account for payment of financial transactions and product transactions through approval of non-related persons unrelated to the user by connecting to a financial transaction system; generating, by the financial transaction system, dedicated account information of a user based on an opening factor input or selected by the user; selecting, by the user terminal, a product in the online shopping mall operated and managed by a product transaction management computer, and requesting payment using the dedicated account information; requesting, by the product transaction management computer, payment approval of the product transaction based on the dedicated account information to the financial transaction system; requesting, by the financial transaction system, approval of the user's financial details and product transaction payment details from at least one non-related person who is not related to the user based on the user's dedicated account information; receiving, by the financial transaction system, transaction approval information of the non-related persons and transmitting product transaction payment approval information to the product transaction management computer; and transmitting, by the product transaction management computer, product transaction payment completion information to the user terminal and sharing a ledger including the user's product transaction details and transaction approval information of non-related persons with users, sellers, and non-related persons.

According to a sixth aspect of the present invention, a product transaction method including: transmitting, by a product transaction management computer which operates and manages an online shopping mall, a request for product marketability verification of registered product information of a seller to a collective intelligence convergence system; requesting, by the collective intelligence convergence system, expert opinions and detailed knowledge about product marketability verification by providing verification element information of product information to registered experts; requesting, by the collective intelligence convergence system, collective intelligence by providing general participants with expert opinions and detailed knowledge information on the product marketability verification provided by experts; converging, by the collective intelligence convergence system, the collective intelligence on the product marketability verification of the product provided by general participants and transmitting the collective intelligence to the product transaction management computer; performing, by the product transaction management computer, decision-making related to the product marketability verification of the product based on the collective intelligence convergence data related to the product marketability verification of the product; and determining, by the product transaction management computer, exposure ranking of products according to the verified level of product marketability and exposing information of the product to the online shopping mall.

According to a seventh aspect of the present invention, a product transaction method including: verifying, by the product transaction management computer, product marketability including level of factors such as quality, price, and competitiveness with similar products of a seller by using a collective intelligence convergence system; calculating, by the product transaction management computer, incidental costs such as advertising costs required for sales when products similar to those for which product marketability has been verified are sold in other media using a numerical determination system; generating, by the product transaction management computer, transaction details which deducts an amount corresponding to the calculated incidental cost from a product transaction payment amount when the transaction of the product is performed in the online shopping mall; requesting, by the product transaction management computer, approval of the user's transaction details by providing the transaction details generated by the product transaction management computer to at least one non-related person unrelated to the user; receiving, by the product transaction management computer, approval information of the transaction details of the non-related persons and completing the product transaction; and generating and storing, by the commodity transaction management computer, information of the completed product transaction details as a ledger and sharing the ledger with users, sellers, and non-related persons.

According to the present invention, a user who has been authenticated through identity authentication of related persons performs financial transactions and product transactions through a dedicated account of the user and approval of the transaction details of non-related persons of the user. Therefore, since there is no error in product transaction and payment commission is unnecessary in the product transaction through the user's dedicated account, the user purchases the product at a lower price and the seller does not have to pay the payment commission for product transaction.

In addition, the product marketability of product information registered by a seller in an online shopping mall is verified by using a collective intelligence convergence system, and the exposure ranking of products registered in the online product transaction system is determined according to the result of product marketability verification. Therefore, the seller does not have to pay an advertisement cost for the exposure ranking of the product, and the user can purchase the product at a lower price.

Average incidental costs such as advertising costs in relation to products whose the product marketability has been verified are calculated using a numerical determination system, and the amount corresponding to the incidental costs calculated during product transactions is deducted from the payment amount of the product. Transaction details including the transaction amount of the product can be approved by non-related persons unrelated to the user, thereby eliminating errors in product transaction.

In addition, errors in product transactions can be prevented by sharing the transaction details of products generated in the ledger among buyers, sellers, and non-related persons.

### BRIEF DESCRIPTION OF THE DRAWINGS

FIG. 1 is a schematic configuration diagram of an exemplary embodiment of a product transaction system of the present invention.

FIG. 2 is a schematic configuration diagram of an exemplary embodiment of a product transaction management computer of the present invention.

FIG. 3 is a schematic configuration diagram of an example of a product information management unit which is the main part in the product transaction management computer of the present invention.

FIG. 4 is a schematic configuration diagram of an example of a product marketability verification information management unit which is the main part in the product transaction management computer of the present invention.

FIG. 5 is a schematic configuration diagram of an example of a fee information management unit which is the main part in the product transaction management computer of the present invention.

FIG. 6 is a schematic configuration diagram of an example of a product transaction payment information management unit which is the main part in the product transaction management computer of the present invention.

FIG. 7 is a schematic configuration diagram of an example of an identity authentication system which is the main part in the product transaction system of the present invention.

FIG. 8 is a schematic configuration diagram of an example of a financial transaction system which is the main part in the product transaction system of the present invention.

FIG. 9A and FIG. 9B are exemplary views of differential application of sales commission rates according to the exposed state and exposed position of a product page according to the product marketability verification result in the product transaction system of the present invention.

FIG. 10 is a flowchart for describing an embodiment of a product transaction method of the present invention.

FIG. 11 is a flowchart for describing another embodiment of a product transaction method of the present invention.

FIG. 12 is a flowchart for describing another embodiment of a product transaction method of the present invention.

### DETAILED DESCRIPTION OF THE PREFERRED EMBODIMENT

Hereinafter, exemplary embodiments of the present invention will be described in detail with reference to the accompanying drawings.

For convenience of the description of the exemplary embodiments of the present invention, among terms used in the description of the exemplary embodiments of the present invention to be described below, configurations of the present invention may refer to configurations of hardware itself and also refer to configurations of a web program or computer program executed by using the hardware resources. For example, a product transaction management computer, an artificial intelligence computer, and an operating computer of the present invention may be configured of hardware included in each computer, and a computer program, web program, or cloud computing program executed using hardware resources of each computer. In addition, acquaintances, neighbors, relatives, friends, co-workers, schools, classmates, traders, etc. used in the embodiment of the present invention can be collectively used as related persons, and each can be used for the same purpose as related persons. Among the embodiments of the present invention, the artificial intelligence computer may refer to an artificial intelligence computer included in the identity authentication system, and may be a component provided for the financial transaction system of the present invention separately from the artificial intelligence computer included in the identity authentication system. In addition, the artificial intelligence computer is not limited to that term, and may be used instead of various terms that perform functions for implementing an embodiment of the present invention, for example, an analysis computer. In addition, the ‘user interface’ described in the embodiments of the present invention may be a web program or application program that is output or installed in a user terminal and executed. In addition, ‘˜unit or ˜module’ described in the embodiments of the present invention may be replaced with ‘˜means’. Here, ‘˜unit’ or ‘˜means’ may be a component of hardware itself, and may preferably be composed of components of software or programs. In addition, ‘user’ used in the description of the embodiments of the present invention may be used interchangeably with ‘member’ or ‘buyer’.

The terms and enumeration of terms described above are only examples, and various terms and elements not enumerated that can be predicted by a person skilled in the art may of course be included.

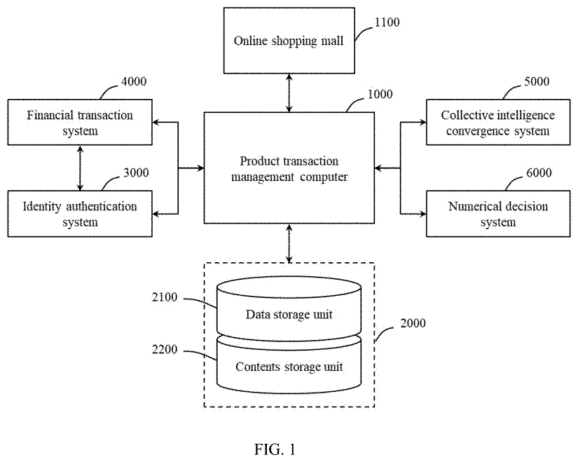

FIG. 1 is a schematic configuration diagram of an exemplary embodiment of a product transaction system of the present invention.

As illustrated in FIG. 1, the product transaction system of the present invention is a configuration including a product transaction management computer 1000 which operates and manages an online shopping mall for product transactions and manages exposure rankings of products registered in the online shopping mall, sales commissions, payment, and the like; a data storage computer 2000 including a data storage unit 2100 that is connected to or included in the product transaction management computer 1000 and stores data including user information, seller information, product selling price information, commission information, etc. performing product transactions in the online shopping mall, and a contents storage unit 2200 for storing product information contents of sellers registered or to be registered in the online shopping mall; an identity authentication system 3000 which performs user authentication of a user who is connected to the product transaction management computer 1000 and performs product transaction through identity verification of at least one related person of the user; a financial transaction system 4000 which generates and manages a dedicated account of the user for which user authentication has been completed for the financial transactions and the product transactions in online shopping mall, and performs financial transactions and product transactions through the dedicated account based on the approval of at least one non-related person unrelated to the user; a collective intelligence convergence system 5000 which determines the exposure ranking of products registered in the online shopping mall and performs the product marketability verification of product information in the product transaction management computer 1000 to determine a sales commission of the product; a numerical determination system 6000 which calculates incidental costs such as advertising costs required to sell similar products of the seller in the online shopping mall; and an online shopping mall 1100 which manages and operates by the product transaction management computer 1000 that registers product information of sellers and performs online product transactions.

The product transaction management computer 1000, the identity authentication system 3000, the financial transaction system 4000, the collective intelligence convergence system 5000, and the numerical value determination system 6000 may each be configured as a server computer capable of executing a web program or a computer program and having a communication means.

The data storage computer 2000 may be configured as a database management system (DBMS) for storing and managing data.

The online shopping mall 1100 may be configured as a store-type shopping mall operated and managed by the product transaction management computer 1000, in which users can trade products online with a URL that can be accessed through a PC or mobile terminal, and sellers can register products.

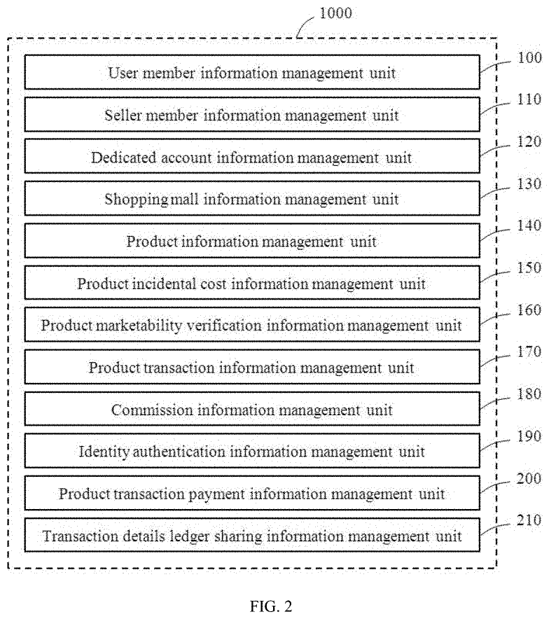

FIG. 2 is a schematic configuration diagram of an exemplary embodiment of a product transaction management computer of the present invention.

More precisely, FIG. 2 shows each component of a web program or computer program that is loaded and executed in the product transaction management computer 1000.

As illustrated in FIG. 2, the product transaction management computer of the present invention is a configuration including a user member information management unit 100 which manages a member information of a user who has joined the product transaction management computer 1000 as a buyer member in order to trade products in the online shopping mall 1100 operated by the product transaction management computer 1000; a seller member information management unit 110 which manages member information of a seller who has joined the product transaction management computer 1000 as a seller member to register and sell products in the online shopping mall 1100; a dedicated account information management unit 120 which manages a dedicated account information opened by a user member who is a buyer or a seller member who is a seller in the financial transaction system 4000 for financial transactions, and product purchase and payment; a shopping mall information management unit 130 which updates the online shopping mall 1100 and manages a bulletin board; a product information management unit 140 which registers product information such as product images and product descriptions to be exposed on the online shopping mall 1100, manages update information of sales price information of products exposed on the online shopping mall, and manages exposure information of the product information on the online shopping mall 1100; a product incidental cost information management unit 150 which requests the collective intelligence convergence system 5000 to calculate incidental costs such as advertising costs required for sales in general online shopping malls in relation to similar products identical to those of the seller, and receives the results, and manages them; a product marketability verification information management unit 160 which requests the collective intelligence convergence system 5000 to verify the product marketability of the product including the presence or absence of competitiveness such as product quality, cost-effectiveness, and selling price in relation to the product to be compared, and receives the results, and manages them; a product transaction information management unit 170 which manages product order and purchase information in the online shopping mall 1100 of the user; a commission information management unit 180 which calculates the sales commission applied to the seller's product as a set value according to the result of the product marketability verified by the product marketability verification information management unit 160 as a set value and applies it to the corresponding product registered in the online shopping mall 1100; an identity authentication information management unit 190 which manages authentication result information through identity verification of related persons in order for a user or seller to apply for opening a dedicated account in the financial transaction system; a product transaction payment information management unit 200 which requests the financial transaction system to approve the product payment amount of the dedicated account when a user proceeds to pay for a product purchase in the online shopping mall 1100 using the dedicated account, transmits the result to the user, and completes the payment of product transaction; and a transaction details ledger sharing information management unit 210 which generates and stores product transaction details, payment details, and payment approval details between the user and the product transaction management computer 1000 as a ledger, and shares and manages the ledger with the user, seller, and non-related persons participating in the payment approval.

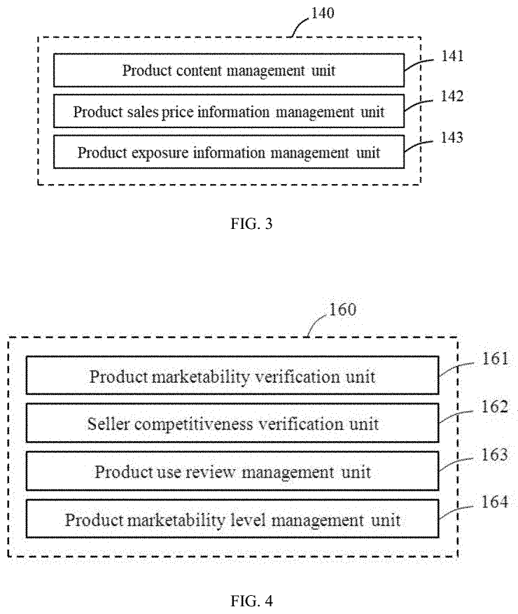

FIG. 3 is a schematic configuration diagram of an example of a product information management unit which is the main part in the product transaction management computer of the present invention.

As illustrated in FIG. 3, the product information management unit 140 of the present invention is a configuration including a product content management unit 141 which receives, stores, and manages information such as a product image, product detailed description, and product sales price input by the seller; a product sales price information management unit 142 which retrieves product sales price information of the seller managed by the product content management unit 141 and adjusts the sales price of the lower product according to a rule set according to the product marketability verification result to expose and manage it on the online shopping mall; and a product exposure information management unit 143 which adjusts and applies rankings exposed to the online shopping mall according to the product marketability level verified by the product marketability verification information management unit 160 and manages the information.

FIG. 4 is a schematic configuration diagram of an example of a product marketability verification information management unit which is the main part in the product transaction management computer of the present invention.

As illustrated in FIG. 4, the product marketability verification information management unit 160 of the present invention is a configuration including a product marketability verification unit 161 which requests the collective intelligence convergence system or a verification team composed of non-related persons of sellers, shopping malls, and buyers to verify the verification of concepts such as consumer satisfaction, which comprehensively judges evaluation factors such as product quality, performance, selling price, and after-sales service, and manages the verification result; a seller competitiveness verification unit 162 which requests the collective intelligence convergence system or a verification team composed of non-related persons of sellers, shopping malls, and buyers to verify the verification of the seller by factors such as marketing competitiveness and service quality regarding the seller of the product verified by the product marketability verification unit 161, and manages the verification result; a product use review management unit 163 which collects reviews of product purchase or use registered on the online shopping mall or other online shopping malls or social network media by users who have purchased the seller's products, and manages the reviews by score at a set level; and a product marketability level management unit 164 which comprehensively judges the product marketability verification result, seller verification result, and use review level verified and managed by the product marketability verification unit 161, the seller competitiveness verification unit 162, and the product use review management unit 163, and sets and manages a final product marketability level according to established rules.

An embodiment of verifying the product marketability verification information management unit 160 of FIG. 4 by dividing it into products, sellers, and reviews has been described, but is not limited thereto, and the product marketability level management unit 164 may set a product marketability level by verifying the product, seller, and review as verification factors, respectively.

In addition, factors for verifying the product marketability and seller competitiveness may be set in various ways. For example, in the case of a product, cost-effectiveness from the buyer's point of view can be further included as one verification factor, and in the case of a seller's competitiveness, for example, sales of the product for a certain period of time can be further included as one verification factor.

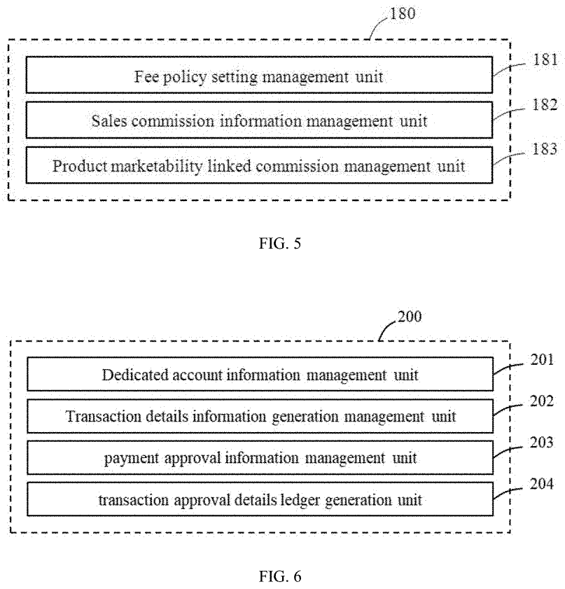

FIG. 5 is a schematic configuration diagram of an example of a fee information management unit which is the main part in the product transaction management computer of the present invention.

As illustrated in FIG. 5, the fee information management unit 180 of the present invention is a configuration including: a fee policy setting management unit 181 which sets and updates a sales commission rate for each product category or product; a sales commission information management unit 182 which calculates and manages commission information to which a sales commission rate set for each product category or product registered in the online shopping mall is applied; and a product marketability linked commission management unit 183 which sets and manages commission rates by category or product that reflect the product marketability level or exposure ranking in online shopping malls.

FIG. 6 is a schematic configuration diagram of an example of a product transaction payment information management unit which is the main part in the product transaction management computer of the present invention.

As illustrated in FIG. 6, the product transaction payment information management unit 200 of the present invention is a configuration including: a dedicated account information management unit 201 which queries the user's exclusive account information and manages whether or not the validity of the exclusive account and financial details for payment approval request by bring the user information and the user's dedicated account information, when the user who has ordered a product from the online shopping mall requests payment for a product transaction using the dedicated account; a transaction details information generation management unit 202 which generates and manages transaction details and payment amount information according to the user's product purchase in association with the user's dedicated account information; a payment approval information management unit 203 which transmits the generated transaction details and payment amount information to the financial transaction system to request payment approval, and transmits and manages payment approval information transmitted from the financial transaction system to a user; and a transaction approval details ledger generation unit 204 which generates and manages a ledger based on the user's transaction details and the transaction details approval information of non-related persons in the financial transaction system.

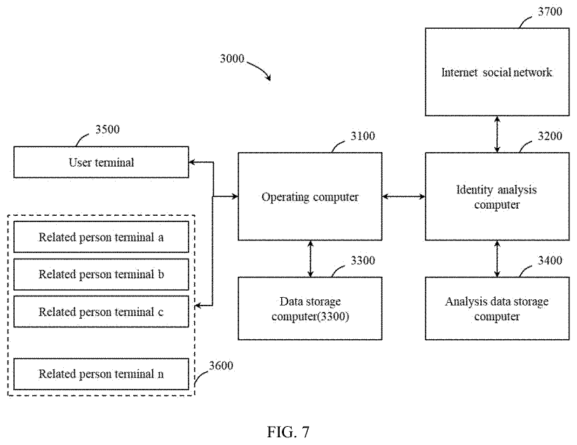

FIG. 7 is a schematic configuration diagram of an example of an identity authentication system which is the main part in the product transaction system of the present invention.

As illustrated in FIG. 7, the identity authentication system 3000 of the present invention is a configuration including: an operating computer 3100 which receives a request for user authentication, receives and manages information on related person groups and related persons around the authentication requester, and manages generated user authentication information and identity verification information; an identity analysis computer 3200 which generates a database by analyzing information such as daily conversations between acquaintances and information such as words used during conversations collected through the Internet social network 3700 such as social network services and Internet media, receives the communication detail information of the related person group according to the user authentication request from the operating computer 3100, performs identity verification, and transmits the identity verification information to the operating computer 3100; a data storage computer 3300 which stores data including identity verification requester information managed by the operation computer 3100, related person group information, related person group communication detail information, and identity verification information transmitted from the identity analysis computer 3200; an analysis data storage computer 3400 including the database generated by the identity analysis computer 3200, an analyzed information of the communication details of the related person group received from the operating computer 3100 analyzed by the identity analysis computer 3200, and analysis information of various data and statistics based thereon of the identity analysis computer 3200; a user authentication request means 3500 provided in a user terminal of an authentication requester that is communicatively connected to the operation computer 3100 to request user authentication and to receive user authentication approval information; and an identity verification data providing means 3600 provided in at least one related person terminal that is communicatively connected to the operation computer 3100 which provides information such as relationship information and communication details with the user authentication requester from related persons such as an acquaintance who has a relationship with the user authentication requester.

Here, the user terminal 3500 of FIG. 7 can be described as a user authentication request means 3500 that is output or executed in the user terminal. The related party terminal 3600 can be described as an identity verification data providing unit 3600 output or executed in the related person terminal.

The configuration of the above-described invention of the present invention, when the user (authentication requester) requests user authentication through the user authentication request means 3500 of the user terminal, the operating computer 3100 receives information such as acquaintances of the authentication requester and communication information of related persons from the authentication requester, and the operation computer 3100 requests and receives relationship information and communication details information with the authentication requester through the related person terminal 3600 to verify whether the authentication requester is the same person, and transmits received communication details information of the related persons to the identity analysis computer 3200 and requests identity verification, and the identity analysis computer 3200 analyzes the received relationship information and communication detail information of the related persons, and the identity analysis computer 3200 determines the consistency of the database of identity authentication-related data collected and created from the Internet social network 3700 and the analysis data, and based on this, determines whether or not the identity is identical, and transmits the identity verification information to the operating computer send to (3100), and the operation computer 3100 generates and stores user authentication approval information of the authentication requester based on the received identity verification information, and transmit to the user terminal 3500.

If the communication detail information is voice information, the corresponding information can be analyzed using voice recognition technology, or by using a voice matching method or a voice-to-text conversion technique.

The relationship information between the related persons and the authentication requester may include, for example, family, relatives, friends, co-workers, schoolmates, friendship members, and hobbyists.

In addition, the communication detail information of the related persons or related person groups includes various types of communication information performed using mobile phones, for example, mobile phone text messages (SMS, MMS, etc.), chatting messages in chatting application programs running on mobile phones, text messages on social network services (SNS), e-mail letters, and Internet voice calls on mobile phones, and the like.

The identity analysis computer 3200 of the identity authentication system 3000 can be described in the same sense as an identity analysis means, which is a computer program that utilizes computer hardware resources.

The identity analysis means includes an analysis-related data collection management means for collecting and managing data such as words, vocabularies, sentences, expressions, etc. used in the relevant relationship in a relationship group composed of related persons of the authentication requester; an analysis-related big data management means for managing the data collected by the analysis-related data collection management means in a database and updating the database; a related person verification data analysis management means for analyzing and managing data for each relation of a related group based on information such as a related person of the authentication requester transmitted from the operation computer; and an identity verification execution management means for judging the consistency of the analyzed data for each relation and the data in the database to determine whether they are identical.

The identity authentication system related to user authentication of the present invention is a configuration including: receiving, by an operation computer, authentication requester information and at least one password from the user terminal of the authentication requester who wants to receive user authentication, and stores it as a member; receiving, by the operating computer, user authentication approval request data including the authentication requester's name and photo, or name, mobile phone number, and password, information of related persons stored in the communication-capable terminal of the authentication requester, and the intention to consent to the use of related persons' information transmitted from the user terminal; transmitting, by the operating computer, an identity verification request message of the authentication requester, which includes authentication requester information including the authentication requester's name and photo, or the authentication requester's name and mobile phone number, to the related person terminals of the related persons of the authentication requester; receiving, by the operating computer, information of related persons, including the relationship with the authentication requester transmitted from the related person terminal, communication details with the authentication requester, and identity verification data necessary for determining whether the authentication requester is identical; transmitting, by the operating computer, information of related persons including communication details with the authentication requester transmitted from the related person terminal to the identity analysis computer to request identity verification determination; determining, by the identity analysis computer, the consistency between relational data analyzing the information of the related persons, including the communication details of the authentication requester and the related persons, transmitted from the operating computer, and relational data managed by a database by analyzing information such as words and expressions used during conversations and daily conversations between acquaintances owned by itself; generating, by the identity analysis computer, identity verification information when the matching result exceeds a certain rate and transmits it to the operating computer; and receiving and storing, by the operating computer, identity verification information of related persons of the authentication requester transmitted from the identity analysis computer, and transmits user authentication approval information generated based thereon to the user terminal.

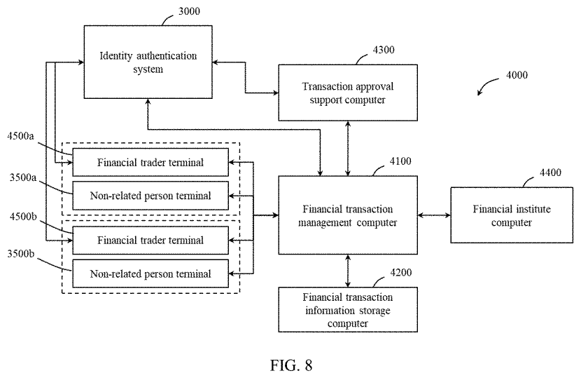

FIG. 8 is a schematic configuration diagram of an example of a financial transaction system which is the main part in the product transaction system of the present invention.

As illustrated in FIG. 8, the financial transaction system of the present invention is a configuration including: a financial transaction management computer 4100 which manages personal information of financial traders, user terminal information, and identification information including account information of financial traders, manages non-related person group information including a number of non-related person information unrelated to the financial trader, receives transaction approval information of non-related person group according to the transaction request of the financial trader, and manages the execution of the financial transaction between the financial trader; a financial transaction information storage computer 4200 that is communicatively connected to the financial transaction management computer 4100 or is included in the financial transaction management computer 4100 and stores data necessary for financial transaction management of the financial transaction management computer 4100; a transaction approval support computer 4300 that is communicatively connected to the financial transaction management computer 4100 and provides resources necessary for the financial transaction approval of the financial trader; a financial institution computer 4400 including at least one bank computer that is communicatively connected to the financial transaction management computer 4100 and executes financial transactions approved by the financial trader; an identity verification system (3000) for approving user verification of the financial trader based on identity verification information of at least one related person of the financial trader; financial transaction terminals 4500a and 4500b used by the financial trader which receives user authentication approval from the identity authentication system 3000 and access the financial transaction management computer 4100 to perform a financial transaction to obtain financial transaction approval from the financial transaction management computer 4100; and a plurality of non-related person terminals 3500a and 3500b used by a plurality of non-related persons unrelated to the financial trader which receive a request from the financial transaction management computer 4100 and provide financial transaction approval information of the financial trader.

In the embodiment of the present invention, it may be configured to have the following characteristics.

The resources provided by the transaction approval support computer 4300 to the financial transaction management computer 4100 are information of non-related persons who are not related to the financial transaction among members of the identity verification system 1000. The financial transaction with the counterparty is performed at the financial trader terminals 3500a and 3500b used by the financial trader that has been approved for user authentication through the identity authentication system 3000. The financial transaction management computer 4100 receives the financial transaction information of the financial trader and confirms the financial transaction intention through the financial trader terminals 4500a and 4500b. The financial transaction management computer provides the transaction information of financial traders to the non-related person terminals 3500a and 3500b of a plurality of non-related persons selected from the financial transaction support computer 4300 or selected from the financial transaction support computer 4300. And, the financial transaction management computer receives information on whether or not to approve the financial transaction of the financial transaction from the plurality of non-related persons, and completes the financial transaction of the financial trader.

The financial trader may correspond to a user in the identity verification system 3000. Also, the financial trader terminals 4500a and 4500b may correspond to the user terminal 3500 in the identity verification system 3000.

A financial trader, a user, accesses the identity authentication system 3000 with a financial trader terminal 4500a and inputs user authentication request data including personal information, password, and information of a number of related persons such as acquaintances of the financial trader for user authentication approval.

The identity authentication system 3000 receives the user authentication request data of the financial trader and transmits an identity verification request of the financial trader to the related person terminals used by the plurality of related persons using the included related person information.

The identity authentication system 3000 performs identity verification based on the consistency between the identity confirmation data of the financial trader received from the plurality of related person terminals and the data it possesses, and then transmits the user authentication approval of the financial trader to the financial trader terminal 4500a.

In addition, when the financial trader terminal 4500a accesses the financial transaction management computer 4100 and requests user authentication approval to perform a financial transaction, the financial transaction management computer 4100 transmits the user verification approval request data of the financial trader to the identity verification system 3000 to perform user authentication of the financial trader.

The financial transaction management computer 4100 stores the unique identification information set by the financial trader in the financial transaction terminal 4500a and approved by the financial transaction management computer 4100 in the financial transaction information storage computer 4200.

The unique identification information of the financial trader may be configured of account information for financial transactions, and the unique identification information of the financial trader, for example, the account information, includes a country code consisting of alphabetic or numeric characters, a set number of area codes, and a combination of unique numbers set by the financial trader within the set number range.

In addition, when the financial trader needs to open several accounts, one or more account information may be opened by combining additional numbers with the combination account information.

The set financial trader's unique identification information can be encrypted and managed. Table 1 below shows an example of the composition of the unique identification information and account information of a financial trader.

TABLE 1

| | country | area | unique | additional | unique identification |
|---|---|---|---|---|---|
| | code | code | number | number | code (account number) |
| guide | English or | three | set within | random | Set unique |
| | numeric | digit | numbers | number | identification |
| | | number | 12 to 20 | | information |
| unique | KR or | 042 | 123456789012345 | | KR042123456789012345 |
| | KOR | | | | |
| add | | | | 5 | KR042123456789012345-5 |
| add | | | | 9 | KR042123456789012345-9 |

As shown in Table 1, the financial transaction management computer 4100 received the financial transaction user's unique identification information (e.g., KR042123456789012345) from the financial trader terminal 4500a and checked whether it overlapped with the stored unique identification information. When the two unique identification information do not overlap, the financial transaction management computer 4100 approves and stores the unique identification information of the financial trader. The financial trader whose identity authentication has been approved enters the financial transaction details into the financial trader terminal 4500a and performs a financial transaction. The financial transaction management computer 4100 receives the details of the financial transaction input to the financial trader terminal, and transmits financial transaction intention confirmation data to the financial trader terminal 4500a to confirm the financial transaction intention of the financial trader. In this case, the financial transaction management computer 4100 may inquire balance information from account information of the financial trader stored in the financial transaction information storage computer 4200.

Among the member information stored in the identity verification system 3000, the transaction approval support computer 4300 connected to the financial transaction management computer 4100 selects a plurality of non-related person information, including non-related person terminal information, from member information that has no relationship with the financial trader according to a set rule or randomly, and provides to the financial transaction management computer 4100. The financial transaction management computer 4100 requests confirmation of the financial transaction details of the financial trader to the non-related person terminals 3500a of the non-related persons, and completes the financial transaction of the financial trader based on the transaction details approval information provided from the plurality of non-related person terminals 3500a. The financial transaction management computer 4100 generates a transaction ledger including completed financial transaction information of the financial trader, stores it in the financial transaction information storage computer 4200 in association with the financial trader information, and stores, in a distributive manner, the corresponding transaction ledger in the financial trader terminal 4500a and a plurality of non-related person terminals 3500a that provided the financial transaction approval information.

In addition, the financial transaction management computer 4100 links a predetermined benefit, for example, a point, to non-related persons who are users of a plurality of non-related terminals 3500a that have provided financial transaction approval information in association with the non-affiliated person information, and stores the profit in the financial transaction information storage computer 4200. An embodiment of the present invention has been described with reference to a financial transaction detail calculation means between the financial traders and a data storage means such as a transaction ledger which utilize hardware physical resources such as a computer program or web program executed or output on the financial transaction management computer 4100, the financial trader terminals 4500a, 4500b, and the non-related person terminals 3500a, 3500b as examples, but the present invention is not limited thereto.

In an embodiment of the financial transaction system of the present invention, financial transaction details input between financial transaction parties and a program for calculating and confirming financial transaction details may be provided using cloud computing system resources.

In addition, a virtual web space of a cloud computing system capable of storing and checking transaction ledgers related to completed financial transaction information is provided to the financial trader and a plurality of non-related persons, and the financial transaction management computer 4100 can be stored, in a distributive manner, the transaction ledgers in the virtual web space of a cloud computing system.

Since the financial transaction system of the present invention utilizes a cloud computing system, the financial traders and non-related persons can use the financial transaction system of the present invention 24 hours a day, 365 days a year, regardless of whether other users access the financial transaction system of the present invention.

When a cloud computing system is introduced in the financial transaction system of the present invention, when a financial trader accesses the financial transaction system of the present invention, the financial transaction details input, transaction details calculation and confirmation program provided by the cloud computing system (for example, calculation function application program) can be automatically checked for virus infection or hacking to ensure safety.

When a cloud computing system is introduced in the financial transaction system of the present invention, approval of financial transactions by non-related persons is automatically performed by a calculation program provided by the cloud computing system. Therefore, it is not necessary for the non-related persons to individually calculate the transaction details to approve the financial transaction.

Of course, when the cloud computing system is not used in the financial transaction system of the present invention, the transaction approval support computer 4300 may be configured to automatically calculate transaction details for the financial transaction approval of non-related persons. Therefore, it is not necessary for the non-related persons to individually calculate the transaction details to approve the financial transaction.

Regarding the benefits provided to non-related persons who provide financial transaction approval information in the embodiment of the financial transaction system of the present invention, the financial transaction management computer 4100 may provide and store predetermined points (eg, 1 point for each financial transaction approval) to the non-related persons as a reward for the approval of the financial transaction by the non-related persons and the storage of the generated transaction ledger.

Considering that non-related persons for financial transaction approval are randomly selected by the transaction approval support computer 4300, there is an effect of providing predetermined points to all members using the financial transaction system of the present invention. The points can be set to be usable like cash in the financial transaction system of the present invention.

As described above, in the embodiment of the financial transaction system of the present invention, financial transaction detail information by financial traders (calculation details between financial transaction parties, etc.) and financial transaction approval information by the non-related persons are stored in the financial transaction management computer 4100, check whether the transaction ledger matches, such as calculation details of financial transaction parties and financial transaction approval details of non-related persons. The financial transaction details calculated by the financial transaction management computer 4100 or the transaction approval support computer 4300 and the transaction ledger are finally checked, and if they match, the financial transaction is finally approved, and generates a transaction ledger of the completed financial transaction, and stores, in a distributive manner, the transaction ledger in each block (financial trader terminal, non-related person terminal, and financial transaction management computer).

Hereinafter, the reasons for involving the non-related persons in the financial transaction system of the present invention regarding the financial transaction approval of the financial traders and the meaning of the financial transaction approval of the non-related persons will be further explained.

Financial transactions in the embodiment of the financial transaction system of the present invention are performed based on information (balance, etc.) contained in unique identification information (account information) assigned to each financial trader. Financial transactions in the embodiment of the financial transaction system of the present invention are performed based on information (balance, etc.) contained in unique identification information (account information) assigned to each financial trader. The initial start of operation of the financial transaction system of the present invention will start with account information of a specific financial trader at 0 (zero), and in the case of partnership with an existing bank, financial transactions may be made with a certain balance filled. Since a financial transaction is ultimately nothing more than details about who gave and received how much to whom, a simple calculation can be performed in approving the financial transaction. Therefore, anyone with a terminal equipped with an application or program that performs four arithmetic calculations can calculate and approve transaction details anywhere. However, if the simple calculation is entrusted to a specific person, forgery and falsification occurs, so the reliability of the financial transaction details can be secured by sharing the financial transaction details with the financial transaction management computer and non-related persons of the financial traders to prevent forgery and falsification. The non-related persons have no incentive to give more or less financial information to people they don't know. Therefore, approval of financial transactions by non-related persons can secure its reliability.

In addition, since the financial transaction system of the present invention is basically configured to be automatically calculated and approved by a calculator application program instead of manually calculating and approving financial transactions of non-related persons, in approving financial transactions, non-related persons burden can be minimized. Therefore, with regard to the approval of financial transactions by non-related persons, the financial transaction system of the present invention may be configured of makes financial transactions based on the balance information of unique identification information (account information) of the financial trader, and the financial transaction details are approved by non-related persons, and the financial transaction approval may be configured to be automatically performed by a randomly selected non-related person terminal or a calculator application program existing in a cloud virtual space. Since the calculator application program exists in all terminals of financial transaction parties, financial transaction management computers (or artificial intelligence computers), and non-related terminals, it is possible to approve financial transactions by determining whether the results calculated by each calculator application program coincide. As long as the calculator application programs of all terminals do not malfunction at the same time, there is no possibility that an error will occur in the calculated value of the financial transaction.

Hereinafter, an example of a financial transaction using the financial transaction system of the present invention will be described in more detail.

An example of utilizing the financial transaction system 4000 of the present invention among members (or among those who sign up as members) stored as members in the identity authentication system 3000 of the present invention will be described.

Among the parties involved in a financial transaction (fund transfer), if the sender is financial trader a, related persons such as acquaintances are b to m of the financial trader a, non-related persons are n to z, and the recipient is assumed to be financial trader A, the financial trader a uses the financial trader terminal 4500a to provide related person information including the related person terminal information of related persons b to m, obtain user authentication approval from the identity authentication system 3000, and enter the details of the financial transaction to transfer 100 to financial trader A.

The financial transaction management computer 4100 confirms that the balance is 100 or more in the unique identification information (account information) of the financial trader a, and sends a confirmation message to the financial transaction terminal 4500a of financial trader a about whether it is correct to transfer 100 to financial trader A, and receives confirmation.

The financial transaction management computer 4100 requests information of non-related persons of the financial trader a necessary for financial transaction approval to the transaction approval support computer 4300.

The transaction approval support computer 4300 extracts non-related person information including information of non-related person terminals of non-related persons n to z who does not have any relationship (relatives, friends, etc., or financial transaction relationship) with the financial trader a among the members stored in the identity authentication system 3000 based on the information of financial trader a, and provided to the financial transaction management computer 4100.

The financial transaction management computer 4100 transmits the details of fund transfer (withdrawal) of the financial trader a to the non-affiliated terminals 3500a of non-related parties n to z provided by the transaction approval support computer 4300, requests approval of the financial transaction details (withdrawal amount) of a, receives financial transaction details approval information from the non-affiliated person terminals 3500a of the non-related persons, decrementing 100 from the account information of the financial trader a, and completes the financial transaction by increasing 100 to the account information of the financial transaction A.

The financial transaction management computer 4100 generates a transaction ledger based on financial transaction details information including details of reduction and increase of 100 in account information of financial trader a and financial trader A and balance information of each account information, and stores, in a distributive manner, financial trader terminal 4500a of financial trader a, financial trader terminal 4500b of financial trader A, non-related terminal 3500a of non-related persons of financial trader a who participated in the approval of financial transaction details, and financial transaction management computer 4100.

Non-related persons who share the transaction ledger are not all non-related persons, but non-related persons who participate in the approval of financial transaction details.

The number of non-related persons participating in financial transaction approval is set in the financial transaction management computer, or the artificial intelligence computer sets the number and is randomly selected, and the selected non-related persons participate in financial transaction approval, and the financial Transaction ledgers can be stored, in a distributive manner, to non-related persons who participated in transaction approval.

In addition, the number of non-related persons to share the transaction ledger may increase or decrease according to the amount of the financial transaction.

After the financial transaction by the financial transaction system of the present invention is stabilized, the artificial intelligence computer can automatically set the number of non-related persons who will participate in financial transaction approval and the number of non-related persons who will share the transaction ledger among them.

In this way, the present invention can solve the problem of low transaction speed and high cost due to distributed storage in all existing nodes or blocks by limiting the number of blocks (non-related person terminals) for distributed storage of the transaction ledger to a set number.

As an example of another financial transaction, even when financial trader B and C transfer funds to financial trader a, the financial transaction is performed through the above-described process. When problems such as incorrect deposits occur when using the financial transaction system of the present invention, It is possible to restore the details of the wrong deposit by consent of a predetermined ratio (e.g., more than half) of non-affiliated persons who approve financial transaction details or by consent to correct transactions in the financial transaction management computer 4100.

In order to extract information of non-related persons from the transaction approval support computer 4300 and provide it to the financial transaction management computer 4100, the transaction approval support computer 4300 refers to the related persons information provided by the financial trader a (or B, C) to obtain identity authentication approval in the identity authentication system 3000, and may be randomly selected a set number of non-related persons among the remaining members excluding the related persons information.

In addition, the transaction approval support computer 4300 refers to the consistency of the relational data related to the related person of members stored in the identity authentication system 3000 and relational data related to the related person that the transaction approval support computer 4300 has itself, and may be randomly selected a set number of non-related persons among the remaining members excluding members who are related to financial trader a (or B, C).

The transaction approval support computer 4300 of the financial transaction system of the present invention may be a computer provided as one component of the identity authentication system 3000, and may be a component independent of the identity analysis computer of the identity authentication system for extracting and providing non-related person information.

Another example of a financial transaction using the financial transaction system of the present invention will be described in more detail.

The following case is explained as an example. For example, financial trader a has a number of related persons including b to e, and a number of non-related persons including x, y, and z, and financial trader n has a number of related persons including f to i, and a number of non-related persons including s, t, and u, and financial trader o has a number of related persons including j to m, and a number of non-related persons including p, q and r.

When financial trader n transfers 50 to financial trader a by utilizing the financial transaction system of the present invention, the procedure of user authentication approval of financial trader n is not different from the above-described procedure through an identity verification a number of related persons including f to i.

The financial transaction management computer 4100 checks whether there is a balance of 50 or more in the unique identification information (account information) of financial trader n. A financial transaction intention to transfer 50 to the account of financial trader a is confirmed to financial trader n.

The financial transaction management computer 4100 calculates a result value of decreasing 50 in the account information of the financial trader n and increasing 50 in the account information of the financial trader a, receives financial transaction approval information of financial trader n from a plurality of non-related persons including s, t, and u of financial trader n provided by the transaction approval support computer 4300, receives financial transaction approval information of financial trader a from a plurality of non-related persons including x, y, and z, of financial trader a, and completes the financial transaction for the transfer of 50 from financial trader n to financial trader a.

The financial transaction management computer 4100 generates and stores transaction ledger based on the details of the transfer of 50 from the financial trader n to the financial trader a, the calculation result of the decrease of 50 in the account of the financial trader n and the increase of 50 in the account of the financial trader a, and stores, in a distributive manner, the transaction in a financial trader terminal of financial trader n, financial trader terminal of financial trader a, non-related persons (including s, t, and u) terminals of financial trader n, and non-related persons (including x, y, and z) terminals of financial trader a.

In addition, in the above example, when the financial trader a transfers 30 to the financial trader o, the financial transaction management computer 4100 checks whether there is a balance of 30 or more in the unique identification information (account information) of the financial trader a, and confirms the financial transaction (withdrawal) intention to transfer 30 to the account of the financial trader o to the financial trader a.

In this case, the financial transaction management computer 4100 may verify the validity of the previous transaction related to the financial trader a.

Since the previous transaction of financial trader a was a transaction in which 50 was transferred from financial trader n, the financial transaction management computer 4100 checks

The financial transaction management computer 4100 checks whether the records of the ledgers stored in the financial transaction terminals of the financial trader n and the financial trader a and the non-related person terminals of non-related persons who participated in financial transaction approval, respectively, match, and if they match, the financial transaction can proceed.

In relation to each entity storing the above transaction ledger, if some data of the transaction ledger is damaged or unverifiable, if the number of holders who can verify the transaction ledger exceeds a certain percentage (e.g., 95%), it can be considered valid and proceed.

The financial transaction management computer 4100 calculates a result value of decreasing 30 in the account information of the financial trader a and increasing 30 in the account information of the financial trader o, receives financial transaction approval information of financial trader a from a plurality of non-related persons including x, y, and z of financial trader a provided by the transaction approval support computer 4300, receives financial transaction approval information of financial trader o from a plurality of non-related persons including p, q, and r, of financial trader o, and completes the financial transaction for the transfer of 30 from financial trader a to financial trader o.

The financial transaction management computer 4100 generates and stores transaction ledger based on the details of the transfer of 30 from the financial trader a to the financial trader o, the calculation result of the decrease of 30 in the account of the financial trader a and the increase of 50 in the account of the financial trader o, and stores, in a distributive manner, the transaction in a financial trader terminal of financial trader a, financial trader terminal of financial trader o, non-related persons (including x, y, and z) terminals of financial trader a, and non-related persons (including p, q, and r) terminals of financial trader o.

An error may occur in the transaction approval support computer 4300 and the financial transaction management computer 4100 among the components of the financial transaction system of the present invention.

In this case, as a control means for the transaction approval support computer 4300 and the financial transaction management computer 4100, in particular, to prevent operational errors, bugs or strong artificial intelligence functions of the transaction approval support computer 4300, using the collective intelligence convergence system (Patent No. 10-1804960), which is a registered patent of the present applicant, it is possible to determine whether or not to correct an error or to determine whether to change a criterion by referring to the collective intelligence convergence system.

Hereinafter, an embodiment of a financial transaction with an existing bank such as the financial institution computer 4400 or an automated teller machine (ATM) will be described using an embodiment of the financial transaction system of the present invention.

In this case, it is assumed that the financial transaction system of the present invention is affiliated with an existing financial institution such as a bank.

A case in which the financial trader a of the financial transaction system of the present invention deposits 300,000 won (KRW) into the account information of the financial trader a through an automated teller machine (ATM) of a bank will be described. The unique identification information (account information) of the financial trader a is opened in the same way as the financial transaction management computer 4100 and the bank. If 300,000 won (KRW) is deposited into the unique identification information (account information) of financial trader a of the financial transaction system using the ATM, 300,000 won (KRW) is charged (the concept of charging points with cash) into the unique identification information (account information) of financial trader a of the financial transaction system.

In addition, a case in which financial trader a in the financial transaction system of the present invention deposits 700,000 won (KRW) into the account information of financial trader b through an automated teller machine (ATM) of a bank will be described. Unique identification information (account information) of the financial trader a and the financial trader b is opened in the same way as the financial transaction management computer 4100 and the bank. When the ATM transfers 700,000 won (KRW) from the unique identification information (account information) of financial trader a of the financial transaction system to the unique identification information (account information) of financial trader b, the financial transaction system 700,000 won (KRW) is charged to the unique identification information (account information) of financial trader b.

In addition, when the financial trader a of the financial transaction system of the present invention transfers 500,000 won from his account of a specific bank to the unique identification information (account information) of the financial trader b of the financial transaction system of the present invention, if the specific bank is a member of the financial transaction system of the present invention, transfer of 500,000 won is performed with the unique identification information (account information) of the financial trader b according to the above-described procedure, and if the specific bank is a non-member of the financial transaction system of the present invention, funds transfer can be performed by utilizing an inter-bank transfer system through a business partnership with the specific bank.

In addition, when the financial trader a wants to withdraw 500,000 won in cash from the unique identification information (account information) of the financial trader a of the financial transaction system of the present invention, the bank's automated teller machine (ATM) can be used to withdraw money.

In this case, the financial transaction system may actually hold more than 500,000 won in the unique identification information (account information) of the financial trader a, or the financial transaction system may transfer an amount equal to the withdrawal amount to the bank.

Hereinafter, the principles of forgery and alteration prevention, personal information protection, and rapid processing of financial transactions of the financial transaction system of the present invention will be described.

The financial transaction system of the present invention shares the transaction ledger, but does not share the transaction ledger with all members (non-related persons), but stores, in a distributive manner, and shares it only with a set number of non-related persons participating in the financial transaction approval.

Therefore, the present invention can perform counterfeiting and tampering prevention functions while solving the problems of the block chain showing the increase in processing cost, decrease in efficiency and decrease in scalability due to the sharing of the transaction ledger to all members (non-related persons).

In addition, the personal information of financial traders is protected by assigning unique identification information (account information) of financial traders in the financial transaction system of the present invention.

In addition, in the financial transaction system of the present invention, all sensitive personal information such as account balances and transaction details related to financial transactions can be encrypted to generate and store a transaction ledger.

For example, when the details of the previous transaction or balance are changed using block chain technology, the value of a specific numerical value is changed, and a function to send an abnormal signal can be added in the financial transaction system of the present invention. And security can be further strengthened by using ‘hash password’ (cryptographic hash function), which cannot be decrypted (recovery of the original content) during encryption.

Here, the cryptographic hash function is a type of hash function, and means a case in which it is difficult to find a relationship between a hash value and an original input value.

In addition, the financial transaction system of the present invention is configured so that the selection of non-related persons is automatically determined at random by an artificial intelligence computer for each transaction, so that manipulation of the transaction ledger by subsumption of non-related persons is impossible.

In addition, in the financial transaction system of the present invention, who approves transactions for each financial transaction details and shares the transaction ledger is recorded as an identification number and managed internally.

This is also encrypted (a hash password can be applied if necessary) so that no one can access it.

In addition, data storage after calculation of financial transaction details and generation of transaction ledgers is encrypted and then stored in a plurality of places such as a financial transaction management system, a cloud computing system, and a virtual web space.

In addition, the present invention is based on storage, in a distributive manner, in order to block data manipulation, counterfeiting, and falsification attempts by malicious forces.

In addition, the financial transaction system of the present invention can solve the problems of forgery and falsification prevention, hacking prevention, and single point of failure by using distributed computing technologies such as distributed cloud, hybrid cloud, and multi-cloud.

In addition, the financial transaction system of the present invention may provide a physical space for data storage such as a transaction ledger on a terminal such as a computer for financial traders and non-related persons to the financial transaction system of the present invention.

In this case, a certain compensation can be paid according to the provision of physical space, and the financial transaction system of the present invention is configured to improve efficiency by distributed computing, block the possibility of data forgery, and increase the possibility of restoring data in case of a problem.

In addition, calculation work such as calculation of financial transaction details after data encryption can be performed using ‘homomorphic encryption technology’.

Homomorphic encryption has the advantage of reducing the risk of data leakage because search, statistical processing, and machine learning are possible without decryption of ciphertext, and decryption is not required in the middle process of data processing.

The financial transaction management computer and the financial transaction information storage computer of the financial transaction system of the present invention can be installed and operated in a plurality of different spaces in order to prevent a single point of failure.

The configuration and description of the collective intelligence convergence system 5000 in FIG. 1 is disclosed as the collective intelligence convergence system and method of Registered Patent No. 10-1804960 (registration date: Nov. 29, 2017) of the present applicant. Therefore, the configuration and description of the collective intelligence convergence system 5000 will be omitted here.

In addition, the configuration and description of the numerical determination system 6000 of FIG. 1 is disclosed as the numerical determination system and method of Registered Patent No. 10-1998825 (registration date: Jul. 4, 2019) of the present applicant. Therefore, the configuration and description of the numerical determination system 6000 will be omitted here.

Hereinafter, the operation of the embodiment of the commodity trading system of the present invention will be described in detail with reference to FIGS. 1 to 8 described above.

A user who wants to trade products for product purchases in the online shopping mall operated by the product transaction management computer 1000 must first open a dedicated account.

To do so, it is necessary to connect to the identity authentication system 3000 to acquire user authentication, and then access the financial transaction system 4000 to open a dedicated account. The identity verification system 3000 receives user authentication request information input to the user terminal 3500. Preferably, the user's identity authentication request information includes the user's personal information, user terminal information, access to communication details of the user terminal, and access consent information to related persons such as the user's acquaintances.

The operating computer 3100 of the identity verification system 3000 requests identity verification regarding whether the user who requested user authentication is the person himself or herself by using the related person terminal information of the user's related persons.

The operating computer 3100, which has received the identity verification (agreement or disagreement) information of the related persons of the user, transmits the communication detail information with the user of the related persons who have agreed to the identity to the identity analysis computer 3200 to request identity authentication.

Here, the relation information between the related persons and the user may include, for example, family, relatives, friends, co-workers, schoolmates, friendship members, and hobbies.

In addition, the communication detail information of the related persons or related person groups includes various types of communication information performed using mobile phones, for example, mobile phone text messages (SMS, MMS, etc.), chatting messages in chatting application programs running on mobile phones, text messages on social network services (SNS), e-mail letters, and Internet voice calls on mobile phones, and the like.

The identity analysis computer 3200 holds data on words, vocabularies, and expressions that are used daily between acquaintances by relationship group, which are owned by itself or collected from social network service (SNS) or Internet media.

The identity analysis computer 3200 calculates the consistency between data of communication history information (words used, vocabulary, expressions, etc.) between related persons and users and data such as words, vocabulary, expressions, etc. related to the identity of acquaintances possessed. If the calculated matching value is greater than or equal to the set value, it is determined as identity authentication, and decision-making data related to identity authentication is transmitted to the operating computer 3100. The operation computer 3100 performs user authentication of the user based on decision-making data related to identity authentication transmitted from the identity analysis computer 3200.

The financial trader terminals 4500a and 4500b using by user who is completed user authentication in the identity authentication system 3000 applies for opening a dedicated account with unique identification information to be linked with the user's bank account information or other financial institution information by connecting with the financial transaction management computer 4100 of the financial transaction system.

The financial transaction management computer 4100 inquires the financial institution information of the person who applied for the opening of the dedicated account to the financial institution computer 4400 to confirm validity, and generates a dedicated account based on the information input by the user and stores in association with the user information, and transmits it to the financial transaction terminal 4500a and 4500b for confirmation.

In this case, the user's exclusive account is configured to provide interest on the balance (general bank interest) as a basis and provide additional interest thereto. If payment for product purchase is made using the product transaction system using the product transaction system, additional interest other than the basic interest may be distributed in proportion to the balance of the exclusive account from the basic business expenses paid by the product seller to the product transaction system at the time of product registration. In addition, the dedicated account may be set to have a payment function as well as a financial transaction. In a state in which the user opens a dedicated account in the financial transaction system 4000, accesses the online shopping mall of the product trading system of the present invention, selects a product, places an order, and requests payment using the user's dedicated account.

The product transaction management computer 1000 receiving the product transaction payment request using the user's dedicated account transmits payment approval request data including user information, product transaction details, and payment amount information to the financial transaction system 4000. The financial transaction management computer 4100 of the financial transaction system 4000 may receive payment approval request data and transmit product transaction payment intention confirmation data to the user terminal to confirm the user's product transaction payment intention.

In this case, the financial transaction management computer 4100 may inquire balance information from the user's dedicated account information stored in the financial transaction information storage computer 4200. The financial transaction management computer 4100 requests payment approval support to the transaction approval support computer 4300 when it is determined that the balance of dedicated account of the user and the product transaction payment amount are valid, and the transaction approval support computer 4300 extracts at least one non-related person information unrelated to the user, shopping mall, and seller, excluding those related to the user, shopping mall, and seller, from the identity verification system 3000, and provides the information to the financial transaction management computer 4100.

Here, a ‘non-related person’ is a person who is not a ‘related person’ according to the identity verification system, and it is required that there is no legal or economic relationship with parties involved in product transactions such as users, shopping malls, and sellers. The relationship can be determined based on communication details such as text messages, phone calls, and e-mails, financial transaction details, and mutual exchange details.

The financial transaction management computer 4100 transmits the user's product transaction details and payment details data to the non-related terminals 3500a and 3500b based on the information of the non-related persons, and requests a decision on whether to approve the product transaction payment.

The financial transaction management computer 4100 receives the user's product transaction payment approval information from the non-related terminals 3500a and 3500b and transmits it to the product transaction management computer 1000, and the product transaction management computer 1000 transmits payment approval information to the user terminal to complete a product transaction between the user and the online shopping mall.

The product transaction management computer 1000 generates a transaction ledger including the user's completed product transaction information and stores it in the data storage unit 2100 in association with the user information, and stores, in a distributive manner, the corresponding transaction ledger in the user terminal, a plurality of non-related person terminals 3500a and 3500b that provided financial transaction approval information.

In addition, the financial transaction management computer 4100 provides certain benefits, for example, points, to non-related persons who are users of a plurality of non-related person terminals 3500a and 3500b that have provided product transaction approval information. The points may be accumulated in association with the non-related person information. The profit given to the non-related persons may be distributed from the predetermined commission revenue charged by the financial transaction system 4000 of the present invention from the user's product transaction payment amount. A predetermined fee charged by the financial transaction system 4000 may be 50% or more cheaper than a credit card payment fee in a general online shopping mall.

Being able to successfully sell a product by registering it in a store-type online shopping mall depends on the state of being exposed to the online shopping mall. That is, the seller's success in selling a product depends on whether it is exposed to a position set by a manager or exposed as a search result through a product search. In general, store-type shopping malls pay expenses, such as advertising costs, to the shopping mall operator in order to expose their products on the top of the shopping mall page. The reality is that the seller's profit decreases according to the payment of expenses such as advertisements, and the users cannot make high-quality product transactions at low cost.

In the present invention, the general online shopping mall has a configuration in which sellers can set the selling price of a product downward by that amount by saving the cost incidentally paid for selling the product.

Sellers using the product transaction system of the present invention can sell products without the need for additional costs such as advertising costs for higher exposure on product pages of online shopping malls.

Accordingly, it is possible to set a comprehensive product quality level in relation to a specific product or specific product category by verifying the product marketability and the seller's competitiveness.

The product marketability of the products, for example, product performance or quality, selling price, cost-effectiveness, and other services such as after-sales service may be used as verification factors.

Therefore, the product marketability level can be set by calculating an average score by converting the level of decision-making using the collective intelligence convergence system, the evaluation by the non-related persons, and product buyers' reviews into scores.

For a product whose product marketability has been verified, incidental costs such as advertising costs to be paid by the seller in order to successfully sell the product in a general online shopping mall are calculated. It is desirable to calculate incidental costs as objectively as possible using a numerical determination system. Sellers who use the product transaction system of the present invention do not have to pay the amount corresponding to the calculated product sales-related incidental costs, so the sales price of the product can be adjusted downward. Accordingly, it is possible to have sufficient price competitiveness with respect to products of the same kind sold in other general online shopping malls.

In this regard, the difference in competitiveness between a seller who registers and sells a product in the product transaction system of the present invention and a seller who registers and sells the same type of product in another online shopping mall is shown in Table 2 below. For convenience, products to be compared for each shopping mall are products of the same type, and the normal sales price is set to 10,000 won (KRW).

TABLE 2

| | | | Price and Sales |
|---|---|---|---|
| Shopping mall | Incidental costs | Sales price | Competitiveness |
| Present shopping mall | 0(0won) | 8,800 | 1 |
| A shopping mall | 15(1500won) | 10,000 | 3 |
| B shopping mall | 13(1300won) | 10,000 | 2 |
| C shopping mall | 20(2000won) | 10,000 | 4 |
| Average incidental | 12(1200won) | | |
| costs | | | |

As can be seen from the above table 2, sellers who sell products in the online shopping mall operated by the product transaction system of the present invention do not require incidental costs such as advertising costs. Therefore, since the sales price of the product can be set at 8,800 won minus 1,200 won, which is the average amount of incidental costs required for the same product, it can be sold, so the price and the seller's sales competitiveness are the highest. However, it can be seen that being able to have the above competitiveness is applied when exposure to an online shopping mall is made and sales are made.

If the product transaction system of the present invention is also a store-type online shopping mall, the rankings exposed to the product pages of the online shopping mall should be set.

In general, exposure of sale products on product pages of online shopping malls is not performed by a seller's will but by a shopping mall manager's setting or programmatically rotated. Therefore, since the will of the seller cannot be intervened in product sales, product sales are not activated.

In the product transaction system of the present invention, the exposure ranking is set and exposed on the product page of the online shopping mall without the burden of incidental costs such as advertising costs of the seller.

The products registered in the product transaction system of the present invention can be set at the seller's request or by self-verifying the product marketability of the product and verifying the seller's competitiveness.

In addition, the level can be set by integrating the product marketability and the seller's competitiveness verification without separating them and performing them as the product marketability.

The product marketability of the present invention can be performed by verification by non-related persons in the financial transaction system and decision-making by the collective intelligence convergence system.

The process of product marketability by non-related persons of the seller will be described.

The product transaction management computer 1000 requests non-related persons information unrelated to the seller by transmitting the registered seller information to the financial transaction system 4000.

According to the request of the product transaction management computer 1000, the financial transaction system 4000 requests the identity authentication system 3000 for information on non-related persons unrelated to the seller information, and transmits the information on non-related persons unrelated to the seller transmitted from the identity authentication system 3000 to the product transaction management computer (1000). The product transaction management computer 1000 extracts a set number of non-related persons from among the transmitted non-related persons according to a set rule or randomly. The product transaction management computer 1000 requests verifying of the product marketability by providing the seller information, product information and verifying factors such as product quality, product cost-effectiveness, product sales price, and other services to non-related person terminals 3500a and 3500b of extracted non-related persons. The non-related persons receive a request for product marketability verification from the product transaction management computer 1000 and verify the product marketability of the seller's product according to an arbitrary form or a provided form. Preferably, by assigning points within the range of points presented for each verification factor, a product marketability verification result is derived and the product marketability data is transmitted to the product transaction management computer 1000. The product transaction management computer 1000 classifies the product marketability data transmitted from the non-related persons by product type or product category, lists them by score, and stores them. In addition, the product marketability verification may be implemented by calculating the average score of scores assigned by non-related persons based on a perfect score of 100 for the product measurement items for each product, arranging the products in descending order of the average score, and comparing the product marketability according to the high or low average score.

In addition, the product marketability of the seller's product by the collective intelligence convergence system is described.

The product transaction management computer 1000 generates product marketability verification request data including detailed information of registered seller products, product sales price, product sales and service policies of the seller, etc., transmits them to the collective intelligence convergence system 5000, and requests the product marketability verification. The collective intelligence convergence system 5000 requests expert opinions by transmitting the product marketability verification request data to registered experts in the corresponding field. The collective intelligence hunting system 5000 receives expert opinions and detailed information related to the product marketability of products to be verified from the experts, sets them as required reading items and selective reading items, provides them to registered general participants, and requests opinions. The collective intelligence convergence system 5000 converges the collective intelligence including the general participants' consent or disagreement opinions on the required reading items and selective reading items and the score information given to the opinions, and determines decision of the product marketability of the products based on the collected collective intelligence, and transmits it to the product transaction management computer. The product transaction management computer 1000 receives decision information of the product marketability from the collective intelligence convergence system 5000, classifies the product marketability data by product type or product category, and lists and stores the data according to each score.

The product transaction management computer 1000 sets and executes exposure rankings of product information so that the product information is exposed in the order of higher product marketability levels on the product page of the online shopping mall according to the product marketability level of verifying result of the product marketability.

As described above, when the exposure ranking of product information is determined and exposed for each level of product marketability, product information corresponding to a low level of the product marketability is exposed at a lower rank in the product page, and sales may not be activated. Therefore, the product transaction management computer 1000 may frequently or periodically perform and reflect the execution of product marketability and product page exposure. Nonetheless, a policy for promoting sales of products that are exposed to the bottom of the product page due to low product quality is required. The product transaction system of the present invention seeks to solve the above problem by differentially applying the sales commission rate of products registered and sold in an online shopping mall.

When the sales commission of a specific product in the product trading system of the present invention is set at 2% of the selling price, the product recognized as a high level as a result of the product quality verification is exposed to the upper position of the set range on the product page and sales are promoted, so the sales commission can be set to 2%. However, the sales commission rate may be differentially applied to products exposed to lower positions within the set range.

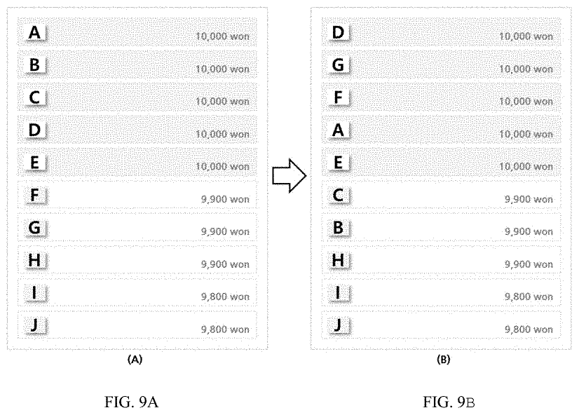

FIG. 9 is an exemplary view of differential application of sales commission rates according to the exposed state and exposed position of a product page according to the product marketability verification result in the product transaction system of the present invention.

For example in FIG. 9, a sales commission rate of 2% is applied to the top 5 products exposed on the product page, a sales commission rate of 1% is applied to lower positions 6 to 8, and a sales commission rate of 0% is applied to the remaining lower position products. Therefore, according to the exposure position, the product sales price is set differently according to the discount or exemption of the commission rate and registered on the product page.

As illustrated in FIG. 9, the product marketability verification is performed frequently or periodically, so that the product page exposure position can be changed and displayed as shown in (A) to (B) in FIG. 9 by changing the level of product marketability.

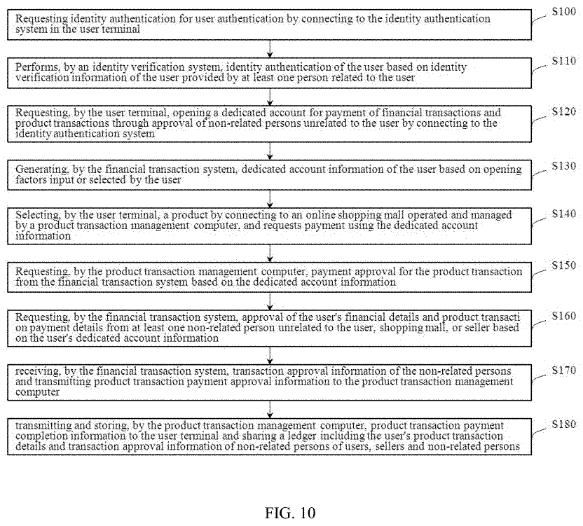

FIG. 10 is a flowchart for describing an embodiment of a product transaction method of the present invention.

As illustrated in FIG. 10, the product transaction method of the present invention includes steps of: requesting, by a user terminal, identity authentication for user authentication by connecting to the identity authentication system (S100); performing, by an identity verification system, identity authentication of the user based on identity verification information of the user provided by at least one person related to the user (S110); requesting, by the user terminal, opening a dedicated account for payment of financial transactions and product transactions through approval of non-related persons unrelated to the user by connecting to the identity authentication system (S120); generating, by the financial transaction system, dedicated account information of the user based on opening factors input or selected by the user (S130); selecting, by the user terminal, a product by connecting to an online shopping mall operated and managed by a product transaction management computer, and requests payment using the dedicated account information (S140); requesting, by the product transaction management computer, payment approval for the product transaction from the financial transaction system based on the dedicated account information (S150); requesting, The financial transaction system, approval of the user's financial details and product transaction payment details from at least one non-related person unrelated to the user, shopping mall, or seller based on the user's dedicated account information (S160); receiving, by the financial transaction system, transaction approval information of the non-related persons and transmitting product transaction payment approval information to the product transaction management computer (S170); and transmitting and storing, by the product transaction management computer, product transaction payment completion information to the user terminal and sharing a ledger including the user's product transaction details and transaction approval information of non-related persons with users, sellers and non-related persons (S180).

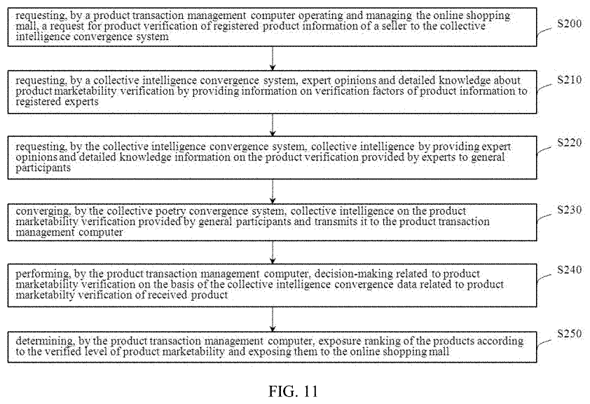

FIG. 11 is a flowchart for describing another embodiment of a product transaction method of the present invention.

As illustrated in FIG. 11, the product transaction method of the present invention includes steps of: requesting, by a product transaction management computer operating and managing the online shopping mall, a request for product marketability verification of registered product information of a seller to the collective intelligence convergence system (S200); requesting, by a collective intelligence convergence system, expert opinions and detailed knowledge about product marketability by providing information on verification factors of product information to registered experts (S210); requesting, by the collective intelligence convergence system, collective intelligence by providing expert opinions and detailed knowledge information on the product marketability provided by experts to general participants (S220; converging, by the collective poetry convergence system, collective intelligence on the product marketability provided by general participants and transmits it to the product transaction management computer (S230); performing, by the product transaction management computer, decision-making related to product marketability verification on the basis of the collective intelligence convergence data related to product marketability of received product (S240); and determining, by the product transaction management computer, exposure ranking of the products according to the verified level of product marketability and exposing them to the online shopping mall (S250).

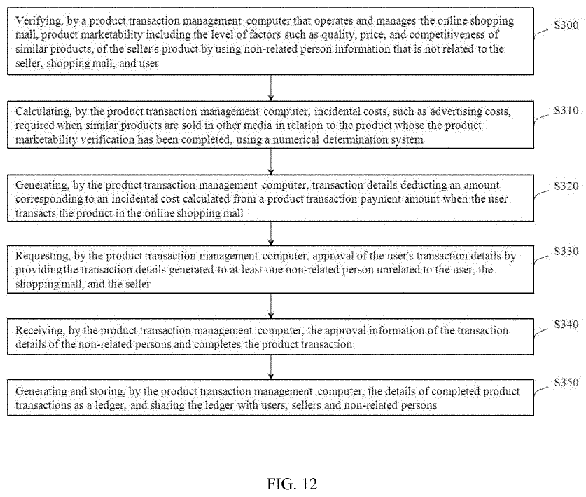

FIG. 12 is a flowchart for describing another embodiment of a product transaction method of the present invention.

As illustrated in FIG. 12, the product transaction method of the present invention includes steps of: verifying, by a product transaction management computer that operates and manages the online shopping mall, product marketability including the level of factors such as quality, price, and competitiveness of similar products, of the seller's product by using non-related person information that is not related to the seller, shopping mall, and user (S300); calculating, by the product transaction management computer, incidental costs, such as advertising costs, required when similar products are sold in other media in relation to the product whose the product marketability verification has been completed, using a numerical determination system (S310); generating, by the product transaction management computer, transaction details deducting an amount corresponding to an incidental cost calculated from a product transaction payment amount when the user transacts the product in the online shopping mall (S320); requesting, by the product transaction management computer, approval of the user's transaction details by providing the transaction details generated to at least one non-related person unrelated to the user, the shopping mall, and the seller (S330); receiving, by the product transaction management computer, the approval information of the transaction details of the non-related persons and completes the product transaction (S340); and generating and storing, by the product transaction management computer, the details of completed product transactions as a ledger, and sharing the ledger with users, sellers and non-related persons (S350).

The product merchantability verification by the non-related persons can be implemented by calculating an average score by assigning points based on a perfect score of 100 for the product marketability measurement items for each product by the non-related persons, arranging the products in descending order of average score, and comparing product quality according to the high and low of the average score.

In the embodiments of FIGS. 11 and 12, it has been described that the product marketability verification is performed by requesting the collective intelligence convergence system, but it is not limited thereto, and the seller of the product and non-related persons unrelated to the shopping mall are not limited thereto. Of course, it can be performed through product marketability verification by non-related persons by requesting information.

The embodiments of the present invention described above are only some of various embodiments of the present invention.

In the product transaction process of the present invention, the user's product transaction payment is performed in the online shopping mall using a dedicated account, but there are various embodiments in which the user's product transaction payment is included in the technical concept of completing the payment through the exclusive account and non-related persons' approval of the product transaction details. It is natural that various exemplary embodiments included in the spirit of the present invention are included in the scope of the present invention.

What is claimed is:

1. A product transaction management computer including at least one hardware processor, and a memory storing instructions that, when executed by the at least one processor, cause the computer to perform:
performing user authentication of transaction parties, including product buyers,
analyzing communication details between each other, extracting information of at least one non-related person who is not related to the product buyers,
requesting payment approval for the product transaction by providing a dedicated account information and product transaction information of the product buyers to non-related person terminal of the at least one extracted non-related person; and
completing the product transaction by receiving payment approval information for the product transaction provided by at least one non-related terminal based on the information of the dedicated account.

2. The product transaction management computer of claim 1, wherein the at least one non-related person terminal is a non-related person terminal of a predetermined number of non-related persons randomly selected from at least one non-related person information.

3. The product transaction management computer of claim 1, wherein the user authentication includes, receiving information on related persons, including acquaintances related to an authentication requester, from the authentication requester who has requested user authentication, requesting the related persons to confirm whether the authentication requester is the person by using the related person terminal information included in the related persons information, analyzing communication details between the authentication requester and related persons based on the identity verification information of the authentication requester provided from the related person terminal, and extracting relationship data representing a specific relationship between people, and determining consistency between a relationship data held by the computer itself representing the specific relationship between people and the extracted relationship data, and verifying the identity of the authentication requester when the consistency is higher than the set value.

4. The product transaction management computer of claim 1, further comprising: paying interest on the balance of the dedicated account of the product buyer, wherein the interest is additional interest in addition to the basic interest by utilizing the financial resources provided by the product seller.

5. A product transaction management computer including at least one hardware processor, and a memory storing instructions that, when executed by the at least one processor, cause the computer to perform:
performing user authentication of transaction parties, including the product seller;
extracting information of at least one non-related person unrelated to the product seller;
requesting a product marketability verification by providing product information of the product seller to at least one non-related person terminal based on the at least one non-related person information;
determining an exposure ranking to the online shopping mall according to information on the product marketability verification of product of the product seller provided by the at least one non-related person terminal, and exposing the product of the product seller to the online shopping mall.

6. The product transaction management computer of claim 5, wherein the at least one non-related person information includes at least one non-related person information excluding related persons related to the product transaction parties including a product seller and an online shopping mall.

7. The product transaction management computer of claim 5, wherein the product marketability verification on the product of the product seller includes, converging scores of non-related persons who participated in the product marketability verification based on consumer satisfaction including quality performance of products, level of after services (A/S) related to the products, and sales price of the products, and determining by calculating the average value of the converged scores of the non-related persons.

8. The product transaction management computer of claim 5, further comprising: setting sales commission information to be paid by the product seller,
wherein the sales commission rate of the product is set differently according to exposure ranking to the online shopping mall determined according to the result of the product marketability verification.

9. The product transaction management computer of claim 8, wherein the sales commission of products exposed below the predetermined rank is applied by discounting or exempting from the normal sales commission of the product exposed to the upper rank, and
wherein the sales price of a product for which the above sales commission is discounted or exempted is set at a lower price by the amount of the discounted or exempted sales commission.

10. A product transaction management computer including at least one hardware processor, and a memory storing instructions that, when executed by the at least one processor, cause the computer to perform:
receiving incidental cost information including advertising costs required to sell the corresponding product in the other online shopping mall for the product of product sellers selling the same or like product as the product seller's product in at least one other online shopping mall and sales price information of the product; and
setting an amount obtained by subtracting the incidental cost from the sales price of the corresponding product as the sales price of the product of the product seller.

11. The product transaction management computer of claim 10, further comprising: calculating an average value of incidental costs including advertising costs of the other online shopping malls; and setting an amount obtained by subtracting the average value of incidental costs from the selling price of the corresponding product as the selling price of the product of the product seller.

12. The product transaction management computer of claim 10, wherein the incidental cost is calculated using a numerical determination system.

13. A product transaction method using a system including a product transaction management computer that operates and manages an online shopping mall, comprising:
Performing, by the product transaction management computer, user authentication of transaction parties including product buyers;
extracting, the product transaction management computer, information of at least one non-related person unrelated to the product buyers by analyzing communication details between the transaction parties;
providing, by the product transaction management computer, dedicated account information of the product buyer and product transaction information to the extracted at least one non-related person terminal and requesting payment approval for the product transaction;
completing, by the product transaction management computer, the product transaction by receiving payment approval information for the product transaction provided by at least one non-related terminal based on the information of the dedicated account.

14. A product transaction method using a system including a product transaction management computer that operates and manages an online shopping mall, comprising:
performing, by the product transaction management computer, user authentication of transaction parties, including the product seller, and extracting information of at least one non-related person unrelated to the product seller;
providing, by the product transaction management computer, product information of the product seller to at least one non-related person terminal based on the at least one non-related person information and requesting product marketability verification; and
exposing, by the product transaction management computer, the product of the product seller to the online shopping mall by determining exposure ranking to the online shopping mall according to information of the product marketability verification of the product of the product seller provided by the at least one non-related terminal.

15. A product transaction method using a system including a product transaction management computer that operates and manages an online shopping mall, comprising:
receiving, by the product transaction management computer, incidental cost information including advertising costs required to sell the corresponding product in the other online shopping mall for the product of product sellers selling the same or like product as the product seller's product in at least one other online shopping mall and sales price information of the product;
calculating, by the product transaction management computer, the incidental cost required for selling the corresponding product in the at least one other online shopping mall; and
setting, by the product transaction management computer, an amount obtained by subtracting the incidental cost from the sales price of the corresponding product as the sales price of the product of the product seller.
